(19) United States
(12) Patent Application Publication
(10) Pub. No.: US 2025/0001655 A1
(43) Pub. Date: Jan. 2, 2025

(54) SYSTEM AND METHOD OF FORMING A MESH STRUCTURE

(71) Applicant: Lear Corporation, Southfield, MI (US)

(72) Inventors: Curtis Hudson, Macomb, MI (US); Eric Repke, Milford, MI (US); Lisa Swikoski, West Bloomfield, MI (US); Joshua Hallock, Warren, MI (US)

(73) Assignee: Lear Corporation, Southfield, MI (US)

(21) Appl. No.: 18/612,513

(22) Filed: Mar. 21, 2024

Related U.S. Application Data
(60) Provisional application No. 63/510,793, filed on Jun. 28, 2023.

(51) Int. Cl. B29C 43/52; B29C 43/00; B29C 43/02; B29K 105/00; B29L 31/00; B60N 2/70

(52) U.S. Cl. CPC B29C 43/52; B29C 43/003; B29C 43/02; B60N 2/7017; B29K 2105/253; B29L 2031/771

(57) ABSTRACT

A system and method of forming a filament mesh structure. The filament mesh structure is placed in a cavity of a mold assembly. Liquid above a first temperature threshold is added to the cavity, thereby softening the filament mesh structure and conforming a shape of the filament mesh structure to a forming surface of the mold assembly. The filament mesh structure is cooled in the mold assembly to set the shape.

### CROSS-REFERENCE TO RELATED APPLICATIONS

This application claims the benefit of U.S. provisional application Ser. No. 63/510,793, filed Jun. 28, 2023, the disclosure of which is hereby incorporated in its entirety by reference herein.

### TECHNICAL FIELD

Various embodiments relate to a system and a method of forming a mesh structure, such as a cushion.

### BRIEF DESCRIPTION OF THE DRAWINGS

FIG. 1 is a perspective view of an example of a seat assembly including a filament mesh structure.

FIG. 2 is a perspective view of an example of a cushion of the seat assembly that is a filament mesh structure.

FIG. 3 is schematic view of an example of a manufacturing system for making the filament mesh structure.

FIG. 4 is an exploded view of an example of a mold assembly and the filament mesh structure before being shaped in the mold assembly.

FIG. 5 is a flowchart of an example of a method of forming the filament mesh structure.

FIGS. 6 and 7 illustrate a first example of adding heated liquid to a cavity of the mold assembly in accordance with the method.

FIGS. 8 and 9 illustrate a second example of adding heated liquid to a cavity of the mold assembly in accordance with the method.

FIGS. 10 and 11 illustrate a third example of adding heated liquid to a cavity of the mold assembly in accordance with the method.

FIGS. 12 and 13 illustrate a first example of cooling the filament mesh structure in accordance with the method.

FIGS. 14 and 15 illustrate a second example of cooling the filament mesh structure in accordance with the method.

FIGS. 16 and 17 illustrate a third example of cooling the filament mesh structure in accordance with the method.

FIGS. 18 and 19 illustrate a fourth example of cooling the filament mesh structure in accordance with the method.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

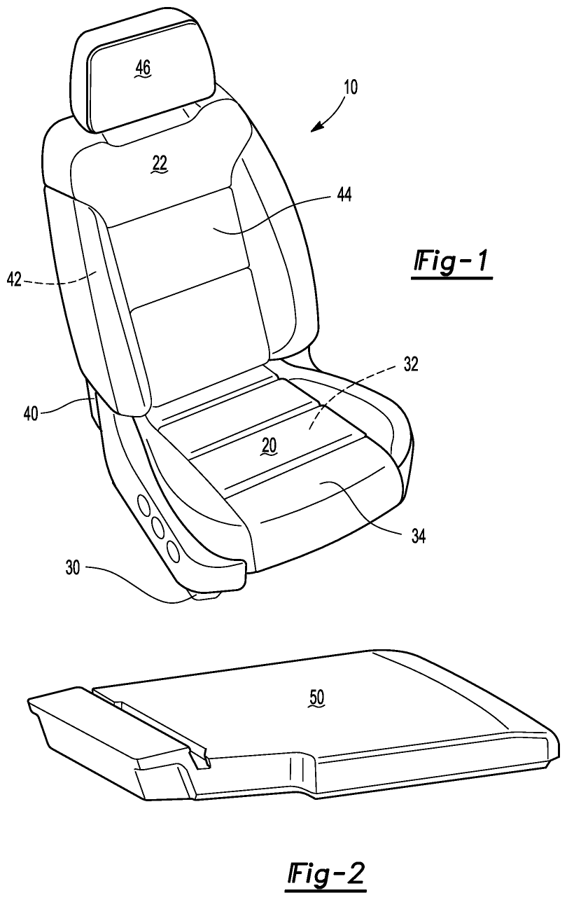

Referring to FIG. 1, an example of a seat assembly 10 is shown. In some embodiments, the seat assembly 10 is a vehicle seat assembly, such as for a land vehicle like a car, truck, bus, or the like, or for a non-land vehicle like aircraft or watercraft. For example, a seat assembly 10 for a land vehicle may be shaped and sized as a front row driver or passenger seat, a second, third, or other rear row seat, and may include bench-style seats, bucket seats, or other seat styles. Furthermore, the seat assembly 10 may be a non-stowable seat or a stowable seat that may be foldable and stowable in a cavity in the vehicle floor. Additionally, the seat assembly 10 may be configured for non-vehicle applications such as furniture.

In the configuration shown in FIG. 1, the seat assembly 10 includes a seat bottom 20 and a seat back 22. It is contemplated that the seat back 22 may be omitted in some configurations, such as when the seat assembly 10 is configured as a motorcycle seat or stool.

The seat bottom 20 is configured to receive a seated occupant and support the pelvis and thighs of the seat occupant. The seat bottom 20 includes a seat bottom frame 30, a cushion 32, and a trim cover 34.

The seat bottom frame 30 is a structure that supports the cushion 32. The seat bottom frame 30 includes one or more structural members and may be made of any suitable material, such as a metal alloy, polymeric material, fiber reinforced polymeric material, or combinations thereof. In some configurations, the seat bottom frame 30 includes a panel, seat pan, suspension mat, or suspension wires upon which the cushion 32 is disposed.

The cushion 32 is disposed on the seat bottom frame 30. The cushion 32 is made of a compliant material that supports the seat occupant and distributes load forces from the seat occupant to the seat bottom frame 30. The cushion 32 and associated methods of manufacture will be discussed in more detail below.

The trim cover 34 covers at least a portion of the cushion 32. In addition, the trim cover 34 provides one or more visible exterior surfaces of the seat back 22. The seat occupant may be disposed on the trim cover 34 when seated upon the seat assembly 10. The trim cover 34 is made of any suitable material or materials, such as fabric, leather, leatherette, vinyl, or combinations thereof. The trim cover 34 may include a plurality of trim panels that are assembled in any suitable manner, such as by fusing or stitching. The trim cover 34 is attached to the seat bottom frame 30, the cushion 32, or both. For example, the trim cover 34 may include trim attachment features that are attached to the seat bottom frame 30, the cushion 32, or both, to inhibit removal of the trim cover 34 and help conform the trim cover 34 to the contour of the seat bottom frame 30, the cushion 32, or both.

The seat back 22 is configured to support the back of a seated occupant. The seat back 22 is disposed adjacent to the seat bottom 20. For example, the seat back 22 may be disposed above the seat bottom 20 and near the rear side of the seat bottom 20. The seat back 22 extends in a generally upward direction away from the seat bottom 20. In some configurations, the seat back 22 is mounted to the seat bottom 20 and may be pivotable with respect to the seat bottom 20. In other configurations, the seat back 22 is not mounted to the seat bottom 20. For instance, a vehicle seat back may be mounted to the vehicle body structure, such as in some second row seat assemblies. The seat back 22 includes a seat back frame 40, a cushion 42, a trim cover 44, and optionally a head restraint 46.

The seat back frame 40 is a structure that supports the cushion 42. The seat back frame 40 includes one or more structural members and may be made of any suitable material, such as a metal alloy, polymeric material, fiber reinforced polymeric material, or combinations thereof. In some configurations, the seat back frame 40 includes a panel, pan, suspension mat, or suspension wires upon which the cushion 42 is disposed. It is also contemplated that the seat back frame 40 may be integrally formed with the seat bottom frame 30.

The cushion 42 is disposed on the seat back frame 40. The cushion 42 is made of a compliant material that supports the seat occupant and distributes load forces from the seat occupant to the seat back frame 40. It is contemplated that the cushion 42 may be integrally formed with the cushion 32 of the seat bottom 20 or separate from the cushion 32 of the seat bottom 20. The cushion 42 and associated methods of manufacture will be discussed in more detail below.

The trim cover 44 covers at least a portion of the cushion 42. In addition, the trim cover 44 provides one or more visible exterior surfaces of the seat back 22. The seat occupant may be disposed on the trim cover 44 when seated upon the seat assembly 10. The trim cover 44 is made of any suitable material or materials, such as fabric, leather, leatherette, vinyl, or combinations thereof. The trim cover 44 may include a plurality of trim panels that are assembled in any suitable manner, such as by fusing or stitching. The trim cover 44 is attached to the seat back frame 40, the cushion 42, or both. For example, the trim cover 44 may include trim attachment features that are attached to the seat back frame 40, the cushion 42, or both, to inhibit removal of the trim cover 44 and help conform the trim cover 44 to the contour of the seat back frame 40, the cushion 42, or both.

The head restraint 46, if provided, is configured to support the head of a seat occupant. The head restraint 46 is disposed at the top of the seat back 22 or at an end of the seat back 22 that is disposed opposite the seat bottom 20. The head restraint 46 may be moveable in one or more directions with respect to the seat back 22 or may be integrally formed with the seat back 22.

Referring to FIG. 2, an example of a cushion 50 is shown. The cushion is generically designated with reference number 50 for convenience in reference. It is to be understood that the structure and description of the cushion 50 is applicable to the cushion 32 of the seat bottom 20, the cushion 42 of the seat back 22, or both.

The cushion 50 is a non-foam component or includes at least one non-foam component. The non-foam component is primarily referred to as a mesh member or filament mesh structure but may also be referred to as a stranded member, looped member, entangled member, mesh cushion, mesh structure, stranded mesh, looped mesh, entangled mesh, or mesh cushion. In FIG. 2, the cushion 50 is depicted as a non-foam component that does not include a foam component or foam material, such as urethane or polyurethane foam; however, it is contemplated that the cushion 50 may also include a foam component or foam material in addition to a non-foam component to provide additional cushioning or localized cushioning for a seat occupant. For example, foam material may be provided between the cushion 50 and a trim cover (e.g., trim cover 34, 44) that is disposed on the cushion 50, within the cushion 50, or combinations thereof. Reducing the amount of foam material that is provided with the cushion 50 or eliminating foam material from the cushion 50 reduces weight and may improve support and comfort of a seat occupant. In addition, eliminating foam material may facilitate recycling of the cushion 50.

The cushion 50 is primarily described below in the context of a cushion 50 that is a non-foam component that does not include foam material. In this context, the cushion 50 is made of filaments of polymeric material that are randomly bent, curled, or looped and are bonded together as will be discussed in more detail below. A filament is directed bonded to another filament rather than being indirectly bonded with a resin or other intermediate material.

The filaments, which may also be referred to as strands or threads, are made of any suitable material or materials. In some configurations, the filaments are made of a polymeric material or thermoplastic material, such as a thermoplastic resin that is polyamide-based, polyester-based, polyimide-based, polyolefin-based (e.g., polypropylene-based, polyethylene-based, etc.), polystyrene-based, or combinations thereof. As one example, a polyethylene-based filament may be made of linear low density polyethylene (LLPDE). The filament material may be recyclable unlike foam material or more easily recycled than foam material. It is also contemplated that a filament may include reinforcement fibers and that the reinforcement fibers may not be made of a thermoplastic material.

In some configurations, a filament may be a monofilament that is made of a single material. In some configurations, a filament is made of multiple materials. As an example, a filament made of multiple materials may include a core that is made of a first thermoplastic material and a sheath that encircles the core and is made of a second thermoplastic material that differs from the first thermoplastic material. It is contemplated that the cushion 50 may include a combination of monofilaments and filaments that are made of multiple materials and are not monofilaments.

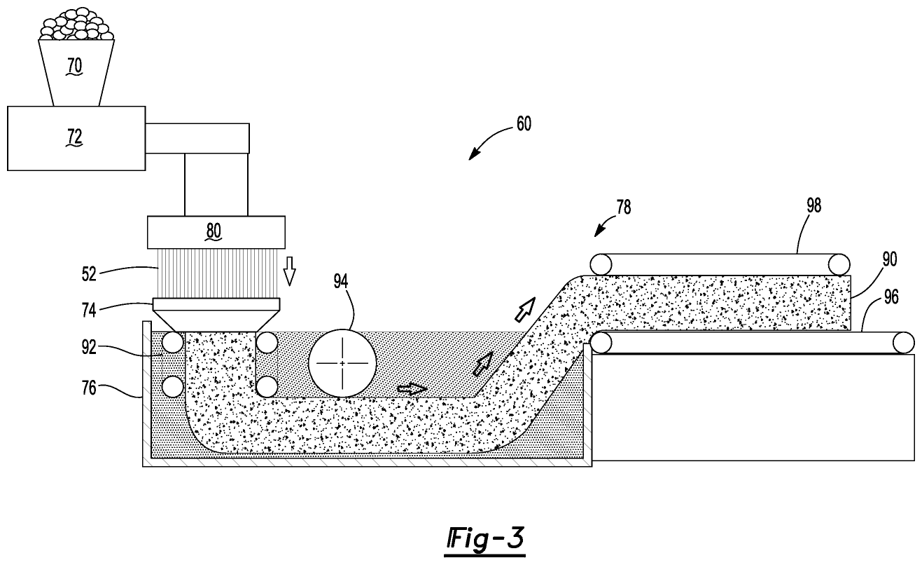

The filaments are randomly bent, looped, curled, or entangled and may be bonded together where one filament contacts another filament, thereby resulting in a lightweight, air permeable cushion (e.g., cushion 32 and/or 42) or mesh structure having openings or voids between the filaments. An example of a method of making a mesh cushion or mesh structure is disclosed in U.S. patent application Ser. No. 17/555,875, which is hereby incorporated by reference in its entirety. An example of a manufacturing system 60 of making a cushion or filament mesh structure is also shown in FIG. 3. In this example, the manufacturing system 60 includes a hopper 70, an extruder 72, a funnel 74, a cooling tank 76, and a material handling subsystem 78.

Referring to FIG. 3, a container or hopper 70 holds material stock that is to be extruded, such as solid beads, flakes, granules, pellets, or powder made of the material. The hopper 70 provides material stock to the extruder 72.

The extruder 72 melts the material stock and extrudes the material stock into filaments 52. The extruder 72 may have any suitable configuration. In some configurations, the extruder 72 includes a barrel that receives a rotatable screw and heating elements. Rotation of the screw forces the material to move through the barrel and helps heat the material due to the friction generated as the screw rotates. The material exits the barrel under pressure and in a molten state and is transported to a die 80 of the extruder 72.

The die 80, which may also be referred to as a die plate or extrusion die, has multiple through holes or filament forming openings through which the molten material passes. A single filament 52 is extruded from each through hole. The filaments 52 fall downward from the die 80 under the force of gravity into the funnel 74.

The funnel 74 consolidates or groups the filaments 52 into a more compact arrangement in which the filaments 52 bend, curl, or loop and a filament 52 contacts and bonds to at least one other filament 52. The funnel 74 has a funnel inlet and a funnel outlet that is smaller than the funnel inlet. Individual separated filaments enter the funnel inlet. The filaments 52 bend, curl, or loop and move into contact as they accumulate. The filaments 52 move through the funnel 74 toward the funnel outlet. Some filaments may slide along the funnel 74 or an intervening sheet that is disposed on the funnel 74 as the filaments move toward the funnel outlet. Each member of the set of filaments 52 may be bonded to at least one other member of the set of filaments 52. Bonds are formed between filaments 52 at the points of contact while openings or voids between filaments 52 are present at other locations where one filament 52 does not contact or bond to another filament 52. The entangled and bonded filaments 52 pass through the funnel outlet of the funnel 74 and enter the cooling tank 76. For convenience in reference, the bonded filaments are referred to as a mesh member or filament mesh structure 90.

The cooling tank 76 holds a liquid, such as water or a mixture of water and another fluid. The liquid in the cooling tank 76 helps support the entangled and bonded filaments 52 to limit further compacting or consolidation of the filaments 52 into a less open or less porous arrangement and maintains a desired porosity and density of the filament mesh structure 90. Thus, the liquid provides some buoyancy or resistance that can result in additional bending, curling, or looping of the filaments 52 adjacent to the surface of the liquid or within the funnel 74 to further build the filament mesh structure 90. The liquid also cools the filaments 52 when the filaments 52 are in the liquid. For instance, the liquid cools the filaments 52 from the outside to solidify the filaments and prevent the filaments 52 from bonding at additional locations. At this point, the filaments 52 are relatively stiff and no longer in a plastic state and thus generally maintain a shape and are not moldable or reformable without being heated.

The material handling subsystem 78 transports the filament mesh structure 90 through the cooling tank 76. The material handling subsystem 78 includes various rollers and conveyors that help move the filament mesh structure 90 through the liquid and out of the liquid. In some configurations, a tractor conveyor 92 is provided in the cooling tank 76 to help pull the filament mesh structure 90 away from the funnel 74 and to counter buoyancy of the filaments 52.

Other rollers, such as roller 94, keep the filament mesh structure 90 submerged in the liquid and guide the filament mesh structure 90 through the cooling tank 76. For example, the roller 94 may guide the filament mesh structure 90 toward a conveyor belt 96 and shaker table 98 that are disposed outside of the cooling tank 76. The shaker table 98 shakes the filament mesh structure 90 while it is on the conveyor belt 96 to remove liquid. Alternatively or in addition, the filament mesh structure 90 may be squeezed to remove liquid, air may be blown toward the filament mesh structure 90 to help remove liquid from the filament mesh structure 90, or both. It is also contemplated that the filament mesh structure 90 may also be allowed to drip dry, or dry in ambient air.

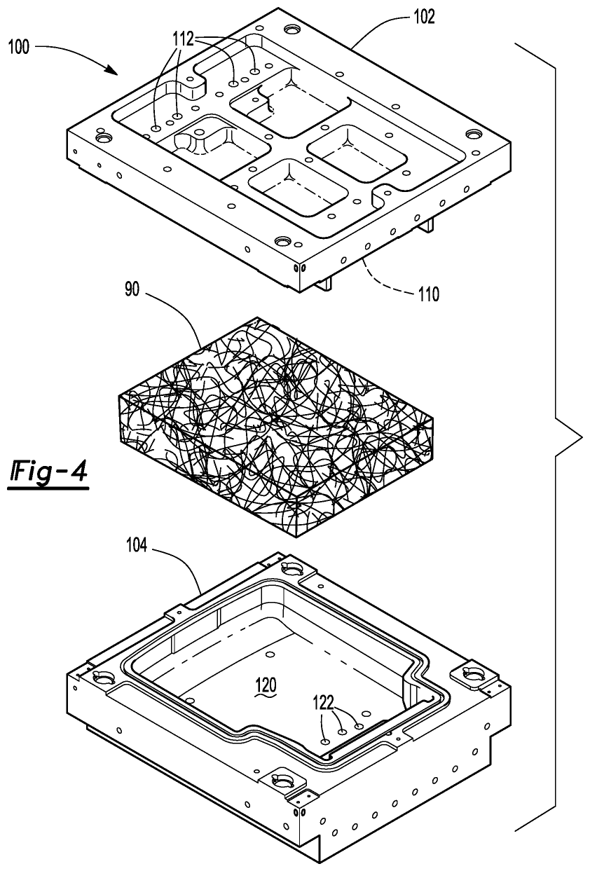

The manufacturing system 60 described above is a continuous flow process in which the filament mesh structure 90 is formed as a continuous structure when filament extrusion is not interrupted. Further processing of the filament mesh structure 90 is provided after exiting the cooling tank 76 to cut the filament mesh structure 90 into individual pieces or blanks for individual cushions. Such processing is conducted by a cutting system of the manufacturing system 60. The cutting system may be of any suitable type. For instance, the cutting system may employ a blade, knife, hot knife, saw, fluid jet, or the like to cut the filaments 52 of the filament mesh structure 90 into a blank. The cutting system may be used to shape or contour the blank. It is also contemplated that a blank may be further shaped or contoured with other manufacturing processes, such as molding of the entire blank or a portion thereof. An example of a piece or blank of the filament mesh structure 90 prior to forming is shown in middle of FIG. 4.

Referring to FIG. 4, an example of a mold assembly 100 is shown. The mold assembly 100 may be part of a molding subsystem of the manufacturing system 60. The mold assembly 100 includes a first mold 102 and a second mold 104. The first mold 102 and the second mold 104 cooperate to define a cavity 106 therebetween, the cavity 106 being shown with hidden lines in the odd numbered figures from FIGS. 7 to 19.

The first mold 102 has a first forming surface 110 that faces toward the filament mesh structure 90. The first forming surface 110 defines a portion of the cavity 106 and is configured to contact and shape the filament mesh structure 90 as will be discussed in more detail below. A plurality of apertures 112 are provided in the first mold 102 and extend from the first forming surface 110. In some configurations, the apertures 112 are fluidly connected to the surrounding environment. The apertures 112 allow gas to exit the cavity 106, allow liquid to enter the cavity 106, or both as will be discussed in more detail below. In some configurations, some or all of the apertures 112 allow gas to exit the mold assembly 100, allow liquid to enter the mold assembly 100, or both.

The second mold 104 has a second forming surface 120 that faces toward the filament mesh structure 90. The second forming surface 120 defines a portion of the cavity 106 and is configured to contact and shape the filament mesh structure 90 as will be discussed in more detail below. A plurality of apertures 122 are provided in the second mold 104 and extend from the second forming surface 120. In some configurations, the apertures 122 are fluidly connected to the surrounding environment. The apertures 122 allow gas to exit the cavity 106, allow liquid to enter the cavity 106, or both as will be discussed in more detail below. In some configurations, some or all of the apertures 122 allow gas to exit the mold assembly 100, allow liquid to enter the mold assembly 100, or both.

In some configurations, an aperture 112, 122 may be selectively fluidly connected to the surrounding environment or to a fluid source outside of the mold assembly 100. For instance, one or more valves may be associated with an aperture 112, 122 and may be opened to allow a fluid to enter the cavity 106 or exit the cavity 106. Thus, fluid may be held in the cavity 106 by closing one or more valves and may be permitted to exit the cavity 106 by opening one or more valves.

The first forming surface 110 and the second forming surface 120 are shaped to mold or form the blank of the filament mesh structure 90. For instance, first and second forming surfaces 110, 120 are shaped to form various contours, features, or shapes in the blank of the filament mesh structure 90, such as planar shapes, nonplanar shapes such as concave, convex, or other complex shapes; channels, recesses, protrusions, curves, chamfers, stepped corners, and the like. The cavity 106 may be sized to have a smaller size or volume than the blank of filament mesh structure 90 such that the mold assembly 100 compresses the blank of filament mesh structure 90 when the mold assembly 100 is closed (e.g., when the first mold 102 and second mold 104 are engaged or mated along corresponding mating surfaces that extend around or encircle a corresponding forming surface).

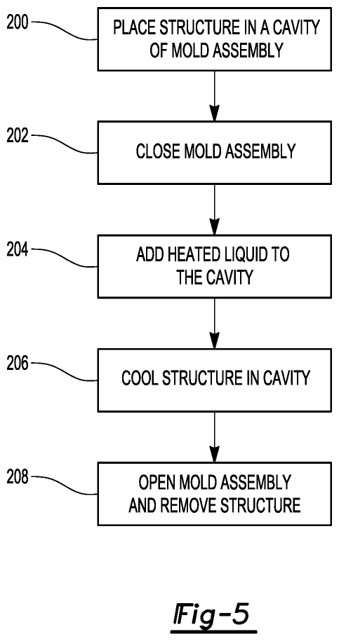

Referring to FIG. 5, a flowchart of a method of forming the filament mesh structure 90 is shown. The method may be performed using the manufacturing system 60. Method steps are described below in the context of molding and forming a blank or piece of the filament mesh structure 90 into a desired configuration or shape. As such, method steps are described beginning with a piece of the filament mesh structure 90 that has been cooled and removed from the cooling tank 76 and cut to a desired size.

At block 200, the piece of the filament mesh structure 90 is placed in the cavity 106 of the mold assembly 100. The piece of the filament mesh structure 90 is placed in the cavity 106 of the mold assembly 100 when the mold assembly 100 is open. The mold assembly 100 is opened by moving at least one of the first mold 102 and the second mold 104 in a manner that permits access to the cavity 106. For instance, the first mold 102 may be disposed above the second mold 104 and may be lifted or pivoted away from the second mold 104 to provide a gap between the first mold 102 and the second mold 104 that is sufficient to permit the piece of the filament mesh structure 90 to be placed in the cavity 106. The piece of the filament mesh structure 90 may be aligned with the first forming surface 110 and the second forming surface 120, thereby permitting the filament mesh structure 90 to engage or contact the first forming surface 110 and the second forming surface 120 when the mold assembly 100 is closed.

At block 202, the mold assembly 100 is closed. The mold assembly 100 is closed by moving at least one of the first mold 102 and the second mold 104 so that the first mold 102 and the second mold 104 engage or mate with each other and cooperate to enclose or define the cavity 106. The filament mesh structure 90 is positioned in the cavity 106 between the first mold 102 and the second mold 104, and more specifically between the first forming surface 110 and the second forming surface 120 when the mold assembly 100 is closed.

In some configurations, the mold assembly 100 is disposed outside of a tank 210 that receives liquid 212 that facilitates softening and forming of the filament mesh structure 90 when the piece of the filament mesh structure 90 is placed in the cavity 106. An example of a tank 210 and liquid 212 is shown in FIG. 7 with the tank 210 being sectioned to show its contents. The mold assembly 100 may not be disposed in the tank 210 when the mold assembly 100 is opened and closed. The tank 210 differs from the cooling tank 76 previously discussed. In such a configuration, multiple mold assemblies may be employed in which one mold assembly 100 is available to receive a piece of the filament mesh structure 90 while another mold assembly 100 that has a piece of the filament mesh structure 90 is undergoing forming operations (e.g., is being heated or cooled), which may help increase throughput.

In some configurations, the mold assembly 100 is at least partially disposed in the tank 210 when the piece of the filament mesh structure 90 is placed in the cavity 106. For example, the first mold 102, the second mold 104, or both may be at least partially disposed in the tank 210 when the piece of the filament mesh structure 90 is placed in the cavity 106. In the example shown in FIG. 7, the first mold 102 is disposed on top of the second mold 104. In such a configuration, the second mold 104 may be disposed in the tank 210 when the piece of the filament mesh structure 90 is placed in the cavity 106. Then, the first mold 102 may be lowered into the tank 210 and positioned to engage and mate with the second mold 104. As another example, the first mold 102 may be pivotally mounted to the second mold 104 that is disposed in the tank 210. In such a configuration, the first mold 102 may be disposed outside of the tank 210, partially in the tank 210, or completely in the tank 210 when the mold assembly 100 is open and the first mold 102 to may be disposed partially or completely in the tank 210 when the mold assembly 100 is closed. Providing at least a portion of the mold assembly 100 in the tank 210 may reduce or avoid material handling associated with moving the mold assembly 100 to or from the tank 210.

At block 204, liquid 212 is added to the cavity 106 of the mold assembly 100. Liquid is added to the cavity 106 after the piece of the filament mesh structure 90 is placed in the cavity 106. The liquid 212 may be of any suitable type. For instance, the liquid 212 may be water or a mixture of water and one or more other liquids.

The liquid 212 is provided to the cavity 106 at a temperature above a first temperature threshold that is sufficient to heat the filaments 52 to allow the filaments 52 of the filament mesh structure 90 to be reformed or reshaped. More specifically, the thermal energy provided by the liquid 212 heats the filaments 52 to a temperature that allows the filament material to be remolded or reformed to a different shape by the compressive force exerted by the mold assembly 100 against the filament mesh structure 90 therein. As such, the liquid 212 softens the filament mesh structure 90 in the cavity 106 so that the shape of the filament mesh structure 90 conforms to a forming surface, such as the first forming surface 110, the second forming surface 120, or both. The thermal energy provided by the liquid 212 softens or plasticizes the filaments 52 to make the filaments 52 compliant without melting the filaments 52. As used herein, the term “compliant” means that the filament material is in a state (e.g., the material is at a temperature) at which its shape can be permanently changed in the mold assembly 100. The liquid 212 is provided in a manner that keeps the temperature of the filaments 52 below the melting temperature of the filament material. As an example, the filaments 52 may be heated by the liquid 212 to a temperature that is 10 to 70° C. less than the melting temperature of the thermoplastic material. Thus, a filament 52 is heated in a manner that is sufficient to allow a filament 52 to be plastically molded or reshaped but that is insufficient to result in a new bond being formed between one filament 52 and another filament 52 or between the filament and itself.

The first temperature threshold may vary based on the filament material employed. As an example, the liquid 212 may be heated to a temperature of 80 to 100° C. when filaments 52 are made of linear low density polyethylene (LLPDE). Temperature may be monitored or determined using a temperature sensor, such as a thermocouple, thermistor, resistance temperature sensor, semiconductor based temperature sensor, or the like.

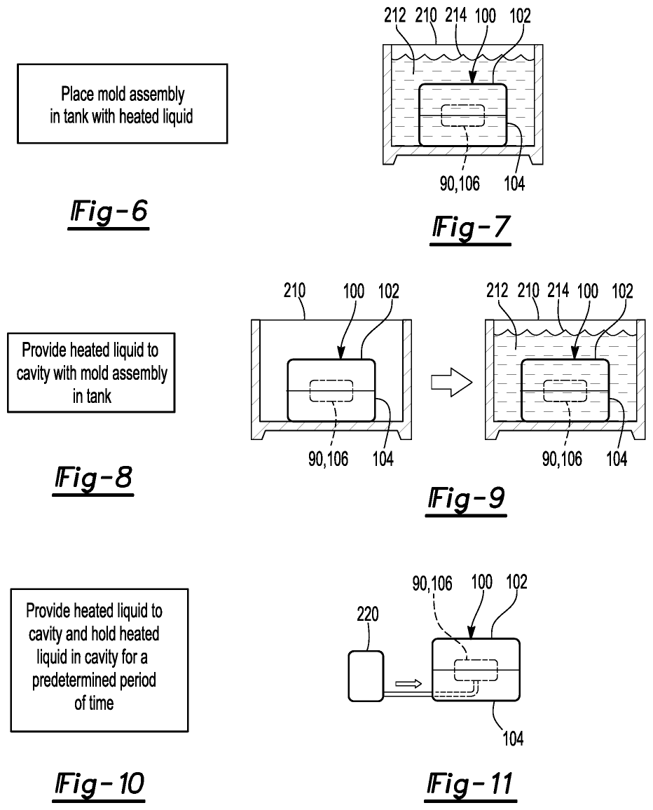

Liquid 212 may be added to the cavity 106 in various ways, examples of which are best shown in FIGS. 6-11. In some configurations, such as the configurations shown in FIGS. 6-9, liquid 212 is added to the cavity 106 when the mold assembly 100 is disposed in the tank 210. In other configurations, such as the configuration shown in FIGS. 10 and 11, adding liquid 212 includes filling the cavity 106 with the liquid 212 without employing a tank 210.

Referring to FIGS. 6 and 7, in some embodiments the mold assembly 100 is placed in a tank 210 that contains the liquid 212. In other words, the tank 210 contains the liquid 212 prior to placing the mold assembly 100 into the tank 210. Providing liquid in the tank 210 prior to placing the mold assembly 100 in the tank 210 may reduce cycle time as compared to placing the mold assembly 100 in the tank 210 and then sufficiently filling the tank 210 with liquid. As such, the mold assembly 100 is placed in the tank 210 after placing the filament mesh structure 90 in the cavity 106. The mold assembly 100 is placed in the tank 210 when the mold assembly 100 is closed. The mold assembly 100 may be placed in the tank 210 in any suitable manner. For example, the mold assembly 100 may be lowered into the tank 210 with a hoist or crane, the mold assembly 100 may be placed on a platform that is lowered into the tank 210, or the like.

Placing the mold assembly 100 in the tank 210 that contains the liquid 212 allows the liquid 212 to enter the cavity 106. Liquid 212 enter various openings of the mold assembly 100 and flows through one or more apertures 112, 122 into the cavity 106. Air is vented from the cavity 106 via various openings or apertures 112, 122 when the liquid 212 enters the cavity 106. For instance, liquid 212 may enter openings and apertures 122 of the second mold 104 as the mold assembly 100 is lowered into the liquid 212. Air exits the cavity 106 through apertures 112 in the first mold 102, apertures 122 in the second mold 104, or both as the mold assembly 100 is lowered into the liquid 212. The mold assembly 100 is partially or completely submerged into the liquid 212. For example, the mold assembly 100 may be positioned in the liquid 212 such that the cavity 106 is positioned below the top surface 214 of the liquid 212, thereby allowing the liquid 212 to fill the cavity 106.

The liquid 212 passes through the voids in the filament mesh structure 90 in the cavity 106 when the liquid 212 fills the cavity 106. As such, the liquid 212 may be distributed in a generally uniform manner throughout the thickness of the filament mesh structure 90, which may help provide generally uniform heating of the filaments 52 of the filament mesh structure 90.

Referring to FIGS. 8 and 9, in some embodiments the liquid 212 is added to the tank 210 after placing the mold assembly 100 in the tank 210. For example, the tank 210 may be empty or may contain liquid 212 at a sufficiently low level such that the liquid 212 cannot enter the cavity 106. Liquid may be stored in a storage tank where it may be kept at a desired temperature or insulated to help avoid heat loss. Then, the tank 210 may be filled or at least partially filled with liquid 212 to a sufficient level such that the liquid 212 fills the cavity 106 as previously described. This is illustrated in FIG. 9 which shows an empty tank 210 on the left in which a closed mold assembly 100 is disposed and shows an example of the tank 210 filled with liquid 212 to a level that submerges the mold assembly 100 on the right.

Referring to FIGS. 10 and 11, in some embodiments the liquid 212 is provided to the cavity 106 without placing the mold assembly 100 in a tank and without submerging or partially submerging the mold assembly 100 in the liquid 212. In such a configuration, the mold assembly 100 may include fewer openings or apertures as previously described and may be configured such that the first mold 102 is sealed against the second mold 104 when the mold assembly 100 is closed. The cavity 106 may be scalable or isolatable from the surrounding ambient air in this configuration. The liquid 212 is provided to the cavity 106, such as from a fluid source 220. The fluid source 220 is fluidly connected to the cavity 106. For example, the fluid source 220 may be fluidly connected to the mold assembly 100 via a conduit, such as a pipe, hose, tube or the like. The mold assembly 100 may have one or more passages that are fluidly connected to the conduit and that extend to a corresponding forming surface. The fluid source 220 may include a pump that may pressurize the liquid 212 and force the liquid 212 into the cavity 106. Gas or air in the cavity 106 may be vented when the cavity 106 is being filled in a manner known by those skilled in the art. It is contemplated that the level of liquid in the cavity 106 can be monitored visually, such as with a sight glass, or with a sensor, such as a liquid level sensor like an optical sensor, capacitance-based sensor, ultrasonic sensor, pressure-based sensor, load cell, the like.

Once the cavity 106 is filled with the liquid 212, the liquid 212 is held in the cavity 106 for a predetermined period of time. The predetermined period of time may vary based on numerous factors, such as the filament material, temperature of the liquid, temperature of the mold assembly 100, temperature of the piece of the filament mesh structure 90 when inserted into the cavity 106, and the like. The predetermined period of time may be determined based on development testing. As a nonlimiting example, the predetermined period of time may be greater than one minute, such as between 1 and 6 minutes; however, it is contemplated that the predetermined period of time may be less than one minute in some configurations. The liquid 212 does not exit the mold assembly 100 when the liquid 212 is held in the cavity 106. For instance, the cavity 106 may be filled with the liquid 212 and one or more valves may be closed to prevent the liquid 212 from exiting the cavity 106 and to prevent additional liquid 212 from entering the cavity 106. As such, the liquid 212 is not circulated into or out of the cavity 106 when the liquid 212 is held in the cavity 106.

At block 206 in FIG. 5, the filament mesh structure 90 is cooled in the cavity 106 of the mold assembly 100. The mold assembly 100 remains closed when the filament mesh structure 90 is being cooled. Removing the filament mesh structure 90 from the mold assembly 100 when the filament mesh structure 90 is in a compliant, softened state may result in the inadvertent alteration or loss of the conforming shape provided by the forming surface. To address this issue, the filament mesh structure 90 is cooled in the mold assembly 100 to set the shape of the filament mesh structure 90 to the forming surface. Cooling the filament mesh structure 90 in the mold assembly 100 includes cooling the filament mesh structure 90 with a fluid to at least a second temperature threshold that is less than the first temperature threshold. The second temperature threshold is selected to be any temperature effective to put the filament mesh structure 90 into a noncompliant state. For example, the second temperature threshold may be below 85° C. for linear low density polyethylene. The cooling fluid may be a gas, a liquid, or a combination of gas and liquid.

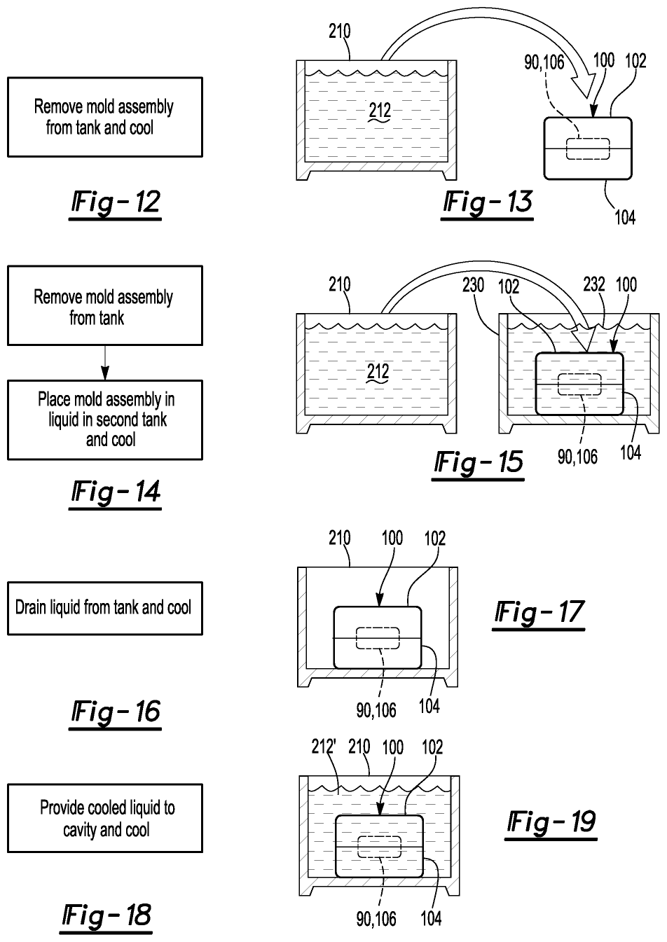

The filament mesh structure 90 may be cooled in various ways, some examples of which are discussed with reference to FIGS. 12-19. In FIGS. 12-15, cooling the filament mesh structure 90 includes removing the mold assembly 100 from the tank 210. In FIGS. 16-19, cooling the filament mesh structure 90 does not include removing the mold assembly 100 from the tank 210.

Referring to FIGS. 12 and 13, in some embodiments cooling the filament mesh structure 90 includes removing the mold assembly 100 from the tank 210 and cooling the filament mesh structure 90 with a gas. This is graphically depicted in FIG. 13. The mold assembly 100 may be removed from the tank 210 by positioning the cavity 106 or the entire mold assembly 100 above the top surface 214 of the liquid 212, such as with a hoist or movable platform. The liquid 212 drains out of the cavity 106 as the mold assembly 100 is removed from the liquid 212 via the various apertures or openings in the mold assembly 100. The liquid 212 is replaced with a gas from the surrounding environment as liquid 212 drains out of the cavity 106. For instance, the gas may be air. The gas that enters the cavity 106 is provided at a temperature that is less than the second predetermined temperature. As a result, the filament mesh structure 90 is cooled with the gas that enters the cavity when the mold assembly 100 is removed from the tank 210. Removing the mold assembly 100 from the tank 210 allows the tank 210 to be available to receive another filament mesh structure 90, which may help increase throughput.

Referring to FIGS. 14 and 15, in some embodiments cooling the filament mesh structure 90 includes removing the mold assembly 100 from the tank 210 and cooling the filament mesh structure 90 with a liquid in a second tank 230. This is graphically depicted in FIG. 15. The mold assembly 100 is removed from the tank 210 and placed in the second tank 230. The mold assembly 100 may be removed from the tank 210 using a hoist, crane, lift or other suitable material handling device and lowered into or otherwise positioned in the second tank 230. The liquid 212 in the tank 210 drains out of the cavity 106 as the mold assembly 100 is removed from the liquid 212 and is replaced with a gas, such as air, as previously discussed. As a result, some cooling with a gas may occur during transport of the mold assembly 100 from the tank 210 to the second tank 230. The gas is replaced with liquid 232 in the second tank 230 as the mold assembly 100 is lowered into the liquid 232. The liquid 232 in the second tank 230 is provided at a temperature that is less than the second predetermined temperature. As a result, the filament mesh structure 90 is cooled in the mold assembly 100 with the liquid 232 that enters the cavity 106 when the mold assembly 100 is placed in the second tank 230, thereby setting the shape of the filament mesh structure 90 to the forming surface of the mold assembly 100.

Referring to FIGS. 16 and 17, in some embodiments the filament mesh structure 90 is cooled in the tank 210 with a gas. The filament mesh structure 90 may be cooled in the tank 210 by draining the liquid 212 from the tank 210 so that gas in the surrounding environment, such as air, enters the cavity 106 and cools the filament mesh structure 90. This is similar to the configuration associated with FIGS. 12 and 13 but instead of removing the mold assembly 100 from the liquid 212 in the tank 210 the liquid 212 is removed from the tank 210 and the mold assembly 100. The liquid 212 may be removed from the tank 210 by draining the tank 210 such as by opening a drain valve. The tank 210 is drained to at least a level that is below the cavity 106, thereby allowing gas to enter the cavity 106 in place of the liquid 212. Draining the tank 210 may help avoid material handling operations associated with removing the mold assembly 100 from the tank 210, which may help reduce cycle time.

In FIGS. 18 and 19, in some embodiments the filament mesh structure 90 is cooled in the tank 210 with a liquid. This may be accomplished in various ways.

In some configurations, the liquid 212 in the tank 210 is cooled to a temperature below the second temperature threshold, thereby cooling the filament mesh structure 90 in the mold assembly 100 to set the shape of the filament mesh structure 90 to the forming surface. For example, the liquid 212 may be circulated out of the cavity 106 to a heat exchanger or other cooling device that cools the liquid 212. The liquid 212 may be returned to the cavity 106 at a lower temperature to facilitate cooling of the filament mesh structure 90. The liquid 212 may be returned to the cavity 106 below the second temperature threshold or may be circulated through the heat exchanger or cooling device multiple times to sufficiently cool the liquid 212 below the second temperature threshold.

In some configurations, the liquid 212 is drained from the cavity 106 and is replaced with liquid having a temperature below the second temperature threshold. For example, the heated liquid 212 may be drained from the tank 210 and hence from the cavity 106. Then, the tank 210 may be filled with liquid 212′ having a temperature below the second temperature threshold, thereby filling the cavity 106 with the cooler liquid 212′. Cooling with a liquid rather than a gas may result in faster cooling of the filament mesh structure 90.

In configurations that do not employ a tank 210, such as the configuration shown associated with FIGS. 10 and 11, cooling may be accomplished by draining the liquid 212 from cavity 106 after holding the liquid 212 in the cavity 106 for the predetermined period of time and replacing the liquid 212 with a gas. For instance, the liquid 212 may be drained from the cavity 106 and replaced with a gas that having a temperature below the second temperature threshold that cools the filament mesh structure 90.

In some configurations that do not employ a tank 210, cooling may be accomplished by draining the liquid 212 from the cavity 106 after holding the 212 liquid in the cavity 106 for the predetermined period of time and then providing liquid at a temperature below the second temperature threshold into the cavity 106 to cool the filament mesh structure 90. The heated liquid that is drained may be stored to help keep the heated liquid at an elevated temperature, which may reduce energy consumption as compared to a configuration that mixes liquid at a temperature below the second temperature threshold to the heated liquid to lower the overall temperature of the liquid.

At block 208, the mold assembly 100 is opened and the cooled filament mesh structure 90 is removed from the cavity 106. The cooled filament mesh structure 90 may now be ready for installation in a seat assembly or may undergo further manufacturing steps.

Clause 1. A method comprising: placing a filament mesh structure in a cavity of a mold assembly, the mold assembly comprising a forming surface; adding liquid at a temperature above a first temperature threshold to the cavity, thereby softening the filament mesh structure and conforming a shape of the filament mesh structure to the forming surface; and cooling the filament mesh structure in the mold assembly to set the shape of the filament mesh structure to the forming surface.

Clause 2. The method of clause 1 wherein liquid is added to the cavity when the mold assembly is disposed in a tank.

Clause 3. The method of clause 2 wherein at least a portion of the mold assembly is disposed in the tank when the mesh member is placed in the cavity of the mold assembly.

Clause 4. The method of clause 2 further comprising placing the mold assembly in the tank after placing the mesh member in the cavity.

Clause 5. The method of clause 4 wherein the tank contains liquid prior to placing the mold assembly in the tank.

Clause 6. The method of clause 4 or clause 5 wherein placing the mold assembly in the tank includes submerging the mold assembly in the liquid.

Clause 7. The method of clause 4 wherein adding liquid includes at least partially filling the tank with liquid after placing the mold assembly in the tank.

Clause 8. The method of any preceding clause wherein cooling the mesh member includes removing the mold assembly from the tank.

Clause 9. The method of clause 8 wherein cooling the mesh member includes cooling the mesh member with a gas.

Clause 10. The method of clause 9 wherein cooling the mesh member includes cooling the mesh member with air that enters the cavity when the mold assembly is removed from the tank.

Clause 11. The method of any of clauses 8 to 10 wherein cooling the mesh member includes placing the mold assembly in a second tank that contains liquid comprising a temperature less than a second temperature threshold, wherein liquid in the second tank enters the cavity and cools the mesh member in the mold assembly to set the shape of the mesh member to the forming surface.

Clause 12. The method of clauses 2 to 7 wherein cooling the mesh member comprises cooling the mesh member in the tank.

Clause 13. The method of clause 12 wherein cooling the mesh member includes draining liquid from the tank so that air enters the cavity and cools the mesh member.

Clause 14. The method of clause 12 wherein cooling the mesh member includes cooling liquid in the tank and the cavity below a second temperature threshold, thereby cooling the mesh member in the mold assembly to set the shape of the mesh member to the forming surface.

Clause 15. The method of clause 12 or clause 13 wherein cooling the mesh member includes draining liquid from the cavity and adding liquid below a second temperature threshold to the tank so that liquid at least partially submerges the mold assembly and enters the cavity, thereby setting the shape of the mesh member to the forming surface.

Clause 16. The method of clause 1 wherein adding liquid includes filling the cavity with liquid and holding liquid in the cavity for a predetermined period of time.

Clause 17. The method of clause 16 wherein liquid does not exit the mold assembly when liquid is held in the cavity.

Clause 18. The method of clause 16 or clause 17 wherein cooling the mesh member includes replacing liquid in the cavity with liquid at a temperature below a second temperature threshold that cools the mesh member in the mold assembly to set the shape of the mesh member to the forming surface.

Clause 19. The method of clause 16 or clause 17 wherein cooling the mesh member includes draining liquid from the cavity after holding the liquid in the cavity for the predetermined period of time, and then providing liquid at a temperature below a second temperature threshold into the cavity that cools the mesh member in the mold assembly to set the shape of the mesh member to the forming surface.

Clause 20. Any of the preceding clauses 1-20 in any combination.

Clause 21. A cushion for a seat assembly, the cushion comprising the mesh member formed by the method of any preceding clause.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method comprising:
placing a mesh member in a cavity of a mold assembly, the mold assembly comprising a forming surface;
adding liquid at a temperature above a first temperature threshold to the cavity, thereby softening the mesh member and conforming a shape of the mesh member to the forming surface; and
cooling the mesh member in the mold assembly to set the shape of the mesh member to the forming surface.

2. The method of claim 1 wherein liquid is added to the cavity when the mold assembly is disposed in a tank.

3. The method of claim 2 wherein at least a portion of the mold assembly is disposed in the tank when the mesh member is placed in the cavity of the mold assembly.

4. The method of claim 2 further comprising placing the mold assembly in the tank after placing the mesh member in the cavity.

5. The method of claim 4 wherein the tank contains liquid prior to placing the mold assembly in the tank.

6. The method of claim 5 wherein placing the mold assembly in the tank includes submerging the mold assembly in the liquid.

7. The method of claim 4 wherein adding liquid includes at least partially filling the tank with liquid after placing the mold assembly in the tank.

8. The method of claim 2 wherein cooling the mesh member includes removing the mold assembly from the tank.

9. The method of claim 8 wherein cooling the mesh member includes cooling the mesh member with a gas.

10. The method of claim 9 wherein cooling the mesh member includes cooling the mesh member with air that enters the cavity when the mold assembly is removed from the tank.

11. The method of claim 8 wherein cooling the mesh member includes placing the mold assembly in a second tank that contains liquid comprising a temperature less than a second temperature threshold, wherein liquid in the second tank enters the cavity and cools the mesh member in the mold assembly to set the shape of the mesh member to the forming surface.

12. The method of claim 2 wherein cooling the mesh member comprises cooling the mesh member in the tank.

13. The method of claim 12 wherein cooling the mesh member includes draining liquid from the tank so that air enters the cavity and cools the mesh member.

14. The method of claim 12 wherein cooling the mesh member includes cooling liquid in the tank and the cavity below a second temperature threshold, thereby cooling the mesh member in the mold assembly to set the shape of the mesh member to the forming surface.

15. The method of claim 12 wherein cooling the mesh member includes draining liquid from the cavity and adding liquid below a second temperature threshold to the tank so that liquid at least partially submerges the mold assembly and enters the cavity, thereby setting the shape of the mesh member to the forming surface.

16. The method of claim 1 wherein adding liquid includes filling the cavity with liquid and holding liquid in the cavity for a predetermined period of time.

17. The method of claim 16 wherein liquid does not exit the mold assembly when liquid is held in the cavity.

18. The method of claim 16 wherein cooling the mesh member includes replacing liquid in the cavity with liquid at a temperature below a second temperature threshold that cools the mesh member in the mold assembly to set the shape of the mesh member to the forming surface.

19. The method of claim 16 wherein cooling the mesh member includes draining liquid from the cavity after holding the liquid in the cavity for the predetermined period of time, and then providing liquid at a temperature below a second temperature threshold into the cavity that cools the mesh member in the mold assembly to set the shape of the mesh member to the forming surface.

20. A cushion for a seat assembly, the cushion comprising the mesh member formed by the method of claim 1.
